(19) United States
(12) Patent Application Publication
(10) Pub. No.: US 2012/0130915 A1
(43) Pub. Date: May 24, 2012

(54) SCORING A MATCHING BETWEEN A RESOURCE AND A JOB

(76) Inventors: Maria Teresa Gonzalez Diaz, Mountain View, CA (US); Cipriano A. Santos, Modesto, CA (US); Shailendra K. Jain, Sunnyvale, CA (US); Xin Zhang, San Jose, CA (US)

(21) Appl. No.: 13/387,331

(22) PCT Filed: Aug. 17, 2009
(86) PCT No.: PCT/US2009/054035

§ 371 Date: Jan. 26, 2012

(51) Int. Cl. G06Q 10/06

(52) U.S. Cl. 705/321

(57) ABSTRACT

A resource is scored based on a matching of the resource to a job. Job attributes for the job and resource attributes for the resource are identified. A hierarchy of the job attributes that includes dependencies between the job attributes is determined. A score for the resource is determined using the hierarchy of the job attributes and the resource attributes. The score represents a matching between the resource and the job.

### RELATED APPLICATION

The present application is related to PCT/US08/81803, entitled “Supply and Demand Consolidation in Employee Resource Planning” by Gonzalez et al., filed on Oct. 30, 2008, which is incorporated by reference in its entirety.

### BACKGROUND

Most business entities and other organizations with large numbers of employees engage in some type of workforce management. Workforce management practices have the goal of ensuring adequate staffing in an organization and increasing the efficiency of workforce resource distribution among the various projects undertaken by the organization. These practices are typically based on a philosophy of maximizing the value of capital invested in compensating employees and achieving quality results from projects performed by the employees.

One particular problem arising in workforce management is identifying qualified candidates for jobs. In many instances, a human resource employee may identify potential candidates by matching candidate attributes, such as college degree, years of experience, and other qualifications, with job criteria. Then, these candidates are interviewed and one may be selected for the job by managers or other people. In many instances, there may not be a candidate that is a perfect match, i.e., possesses all the specified qualifications for the job. In these instances, selecting the best qualified candidates can be tricky, especially for a human resource employee that is not familiar with the job other than by a short description of the job. As a result, the best qualified individuals for a job may not be identified.

### BRIEF DESCRIPTION OF DRAWINGS

The embodiments of the invention will be described in detail in the following description with reference to the following figures.

FIG. 1 illustrates a system configured to score resources to match the resources with jobs, according to an example embodiment;

FIG. 2 illustrates a flowchart for determining a hierarchy of job attributes, according to an example embodiment;

FIG. 3 illustrates a flowchart for scoring a resource, according to an example embodiment;

FIG. 4 illustrates a flowchart for scoring a resource, according to another example embodiment; and

FIG. 5 illustrates a computer system that may be used as a platform for the system and methods, according to an example embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the invention is described with respect to multiple embodiments. At least some of the embodiments may be practiced in combination.

### 1. Overview

According to an example embodiment, a flexible matching tool determines a similarity degree between a resource, such as a person applying for a job, and a job. A resource is described by a set of attributes, and the job is described by a set of job attributes. At least some of the resource attributes (e.g., college degree, years of experience, location of job, technical requirements, etc.) are the same attributes as the job attributes so the resource can be compared to the job attributes to determine how similar or qualified the resource is for the job. The similarity degree represents how close a match the resource is for the job. This is an indication of how well qualified the resource is for the job. In one embodiment, the similarity degree is a score for the matching between the resource and the job, and is based on the level or degree of similarity between the resource attributes and job attributes, and the dependency of the job attributes and the priority of the job attributes specified in a hierarchy. The scoring is used to determine a resource that is a best candidate for the job, including when resources are not fully qualified for the job. Not fully qualified means the resource does not have all the specified requirements for the job.

The flexible matching tool may also takes into consideration resource transition rules that allows a resource to qualify for a job through training. A transition rule is a rule that indicates whether a resource can qualify for a job through training if the resource possesses certain attributes. Managers or other people specify whether a resource can be trained for a job if the resource possesses a predetermined set of attributes. If a resource can be trained for the job, this may result in a higher similarity degree for the resource. By allowing for transition rules, more resources can be identified that are potential matches for a job.

### 2. System Diagram

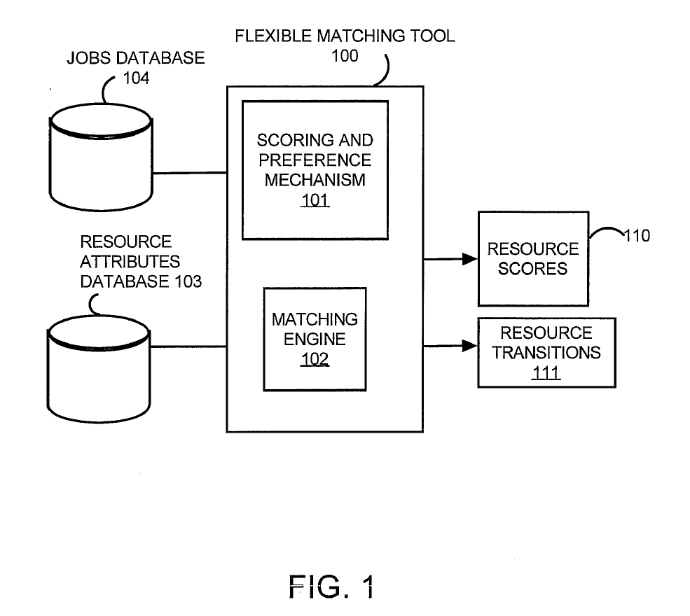

FIG. 1 illustrates a flexible matching tool 100, according to an example embodiment. The flexible matching tool 100 may be software, hardware or a combination of hardware or software. The flexible matching tool 100 may be software stored on a computer readable storage device, and executed by a computer system.

The flexible matching tool 100 includes a matching engine 102 and a scaling and preference mechanism 101. The flexible matching tool 100 is connected to a resource attributes database 103 and a jobs database 104. The resource attributes database 103 stores resource attributes for each resource. For example, the qualifications of each candidate for a job, which may be taken from resumes or are otherwise provided, are entered in the resource attributes database 103 as resource attributes. The jobs database 104 stores job attributes. For each job, the scaling and preference mechanism 101 determines a hierarchy of the job attributes including dependencies (also referred to as preferences) between the job attributes, which is described in further detail below. The hierarchy of the job attributes is stored in the jobs database 104 for the corresponding job.

The matching engine 102 determines a degree of similarity between each resource and the job. In one embodiment, a scoring function, described in detail below, is used to determine the score for each resource, which represents how close a match the resource is for the job. The flexible matching tool 100 may output a score for each comparison of a resource to a job, and the output is shown as resource scores 110. The output can be all the scores for resources applying for a job, or the output may be a top K list, where K is an integer greater than or equal to 1, representing the resources that best match the job. The comparison of the resource attributes to job attributes for a job uses the hierarchy of the job attributes determined by the scaling and preference mechanism 101 and stored in the jobs database 104. Also, transition rules or secondary skills for resources may be considered when determining the similarity score between a resource and a job. For example, the jobs database 104 stores transition rules for jobs. If a resource is not fully qualified for a job, the matching engine 102 accesses transition rules for the job to determine whether the resource can become qualified. For example, if the rules specify that if the resource has a score greater than a threshold and the resource has a certain skill set, then the rules indicate that with certain training the resource can become qualified for the job. This indication is included in the resource transitions 111 generated by the tool 100.

### 3. Scaling and Preference Mechanism

As indicated above, the scaling and preference mechanism 101 determines a hierarchy of the job attributes. The hierarchy includes weights for each job attribute corresponding to the importance of the job attribute when compared to the other job attributes and also identifies the order of the job attributes based on their importance. Business rules provided by resource managers or other workforce planners are translated into quantitative values (e.g., weight for each job attribute) and also identify the dependency across the job attributes to define a hierarchy of job attributes. The weight for each attribute is determined from the preferences (i.e., dependencies) between the attributes.

In one embodiment, to determine the importance or priority of the job attributes, a scale for comparison between job attributes is determined. One example of such scale is as follows. The scale has values from 1 to 9, using values 1, 3, 5, 7, and 9 as the main values of the scale and values 2, 4, 6, and 8 if we are not sure whether a main value of the scale applies to describe the dependency between the job attributes. For example, when comparing two job attributes a1 and a2 using the scale, 1 is equal importance; i.e., a1 and a2 job attributes contribute equally to the employee's qualification to perform the job; 2 is weak importance, i.e., a1 is slightly more important than a2 to perform the job; 3 is moderate importance, i.e., experience and judgment favors a1 over a2 to perform the job; 4 is moderate plus, i.e., a1 is more than moderately important with respect to a2 to perform the job; 5 is strong importance, i.e., experience and judgment strongly favors a1 over a2 to perform the job; 6 is strong plus. i.e., a1 is more than strongly important with respect to a2 to perform the job; 7 is very strong importance, i.e., dominance demonstrated in practice of a1 over a2 to perform the job; 8 is very, very strong, i.e., a1 is almost extremely more important with respect to a2 to perform the job; and 9 is extreme importance, i.e., the evidence favoring a1 over a2 is of the highest possible order.

When comparing job attributes, managers or workforce planners can use the scale to assign a value to each pair of job attributes being compared. These values represent the preferences between job attributes. A matrix A is generated from the values representing the preferences between job attributes. The rows and columns of the matrix A are the job attributes under consideration and the elements of the matrix are the values representing the preference between two attributes.

The matrix A is an nxn matrix, i.e., Aₙₓₙ, where n is the number of job attributes for the job. Aₙₓₙ is a matrix of comparisons of the n job attributes, and Wₙₓ₁ is a column vector of values from the scale for a particular job attribute being compared to each other job attribute. It can be shown that AₙₓₙWₙₓ₁=nWₙₓ₁. Therefore, the vector Wₙₓ₁ is i the principal Eigen-vector of the matrix Aₙₓₙ of job attribute comparisons.

Since the matrix A is anti-symmetric, i.e., a_{j,i}=1/a_{i,j} with a diagonal of 1, a manager needs to determine a value from the scale for each n*(n−1)/2 comparisons of job attributes in pairs. As one embodiment multiple managers may each determine values for each comparison, and for each cell of the matrix Aₙₓₙ, a rounded value calculated from the average of the values from each manager may be used. The principal Eigen-vector of the matrix Aₙₓₘ is used to determine the maximum weights of each job attribute, and is used to score the job-employee matching.

An example is now described to illustrate how to consider job attribute dependencies when scoring the job-resource matching. Assume the following weights were derived from the Eigen-vector of the matrix Aₙₓₙ for five job attributes. The weights represent the principal Eigen-vector of the matrix Aₙₓₙ determined, for example, by a group of managers. In an another embodiment, this weights can be simply determined by a voting scheme from a group of managers. The weights are as follows for the corresponding job attributes:

skill group 50;

workforce type 20;

location 15;

business domain 10; and

job level 5.

This list of job attributes is a hierarchical list where skill group is the most important job attribute and job level is the least important job attribute.

Assume a resource E1 matches all the job attributes, then the job-resource matching score is 100; i.e. a perfect matching. Assume a resource E2 matches all the job attributes except workforce type. Assume that if the highest priority job attribute is not matched by the resource attribute, then there is no matching at all. Thus, in the example above, the least value of a matching, other than 0 for no match, is 50. The weight of job attributes excluding skill group is 50 (20+15+10+5), and the weight of workforce type is 20. Therefore, the remaining weight for the job attributes location, business domain and job level is 30.

In this example, because E2 does not possess the workforce type, all the weights for the job attributes in the hierarchy below workforce type, i.e., location, business domain and job level, are re-scaled for the resource E2. Considering that their total weight (30) represent only 60% (30/50) of the total weight of job attributes for workforce type, location, business domain, and job level, the adjusted weights considering the hierarchy are as follows: skill group is 50; workforce type is 0, location is 15*0.6=9, business domain is 10*0.6=6; and job level is 5*0.6=3. The matching score for employee E2 is 68.

Consider now a resource E3 is only qualified for skill group, location and job level. As before, in the absence of workforce type the re-scaled total weight of location is 60%. In the absence of business domain, the re-scaled total weight for job level is 33.33% (5/15). Therefore, the adjusted weights are as follows: skill group is 50; workforce type is 0; location is 15*0.6=9; business domain is 0; and job level is 5*0.333=1.667. The matching score for the resource E3 is 60.67.

### 4. Method for the Scaling and Preference Mechanism

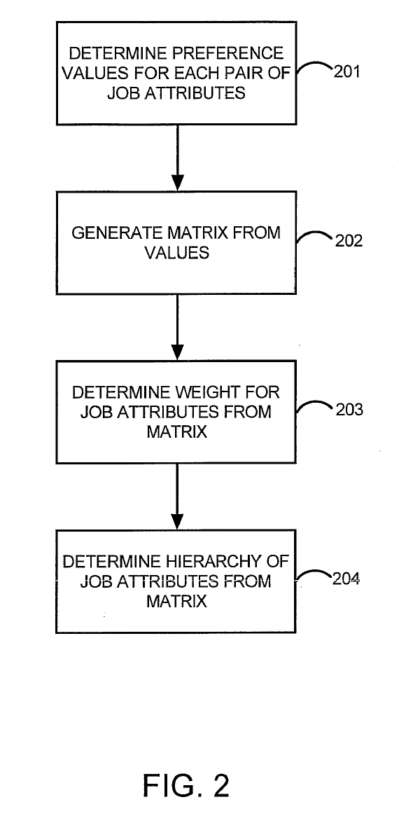

FIG. 2 illustrates an example method 200 for determining a hierarchy and dependencies between job attributes for a job. The method 200 is described by way of example with respect to the system shown in FIG. 1. One or more of the steps of the method 200 may be performed by the scaling and preference mechanism 101.

At step 201, workforce planners or managers or other people or systems determine values representing a relationship between each pair of job attributes. Each job attribute is compared to each of the other job attributes, one at a time. Thus, job attributes in a pair are compared to each other. For example, for 3 job attributes A, B , and C, there are three pairs of job attributes A-B, A-C, and B-C. A comparison is performed for each pair. As described above, a scale may be used to determine the values. The values represent the preference between job attributes. A matrix A is generated from the values representing the preference between job attributes.

At step 202, a matrix Aₙₓₙ is generated from the values determined at step 201. For example, the scaling of preference mechanism 101 receives the values representing the preferences between job attributes from managers or from other people or systems. The scaling of preference mechanism 101 inserts values into the matrix Aₙₓₙ where n is the number of job attributes. Each column of the matrix includes values resulting from the preference comparison of one of the job attributes to each of the other job attributes. Multiple managers may determine values, and these values can be averaged to determine a single value for a cell in the matrix.

At step 203, weights for the job attributes are determined from the matrix. For example, the scaling and preference mechanism 101 determines the principal Eigen-vector from the matrix Aₙₓₙ. The Eigen-vector is used to determine the weights of each job attribute.

At step 204, a hierarchy of the job attributes is determined from the assigned weights. For example, an ordered list of the job attributes is generated that orders the job attributes from highest to lowest weights, and identifies the weight for each job attribute. The ordered list is stored in the jobs database 104. The hierarchy may also include the weights for each job attribute. In another embodiment, this scaling of preferences mechanism 102 can be implemented by a voting process from the group of managers.

### 5. Matching Engine

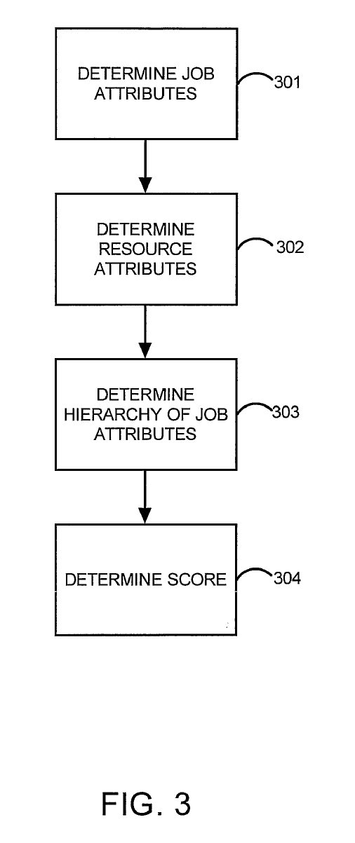

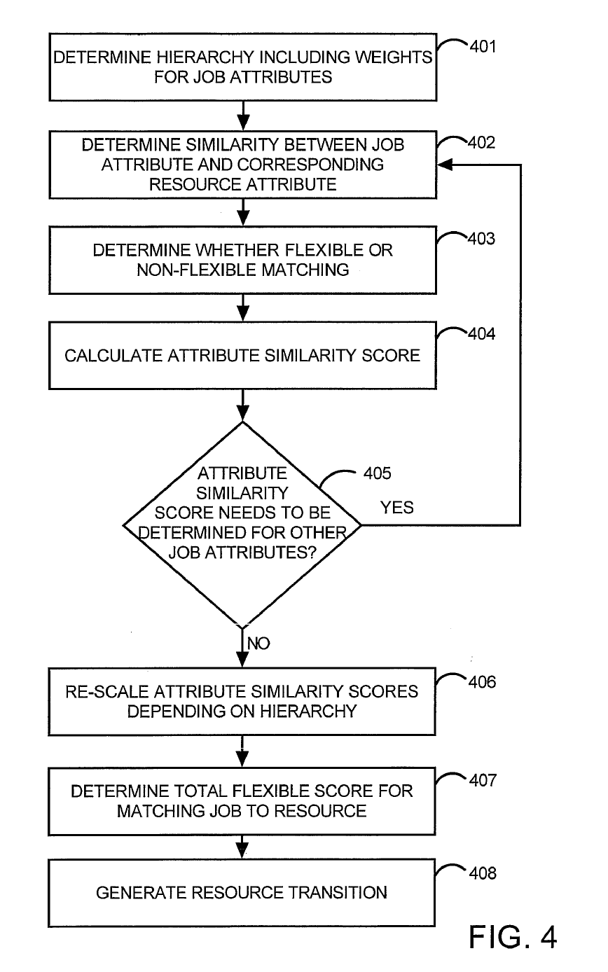

Once the values for the matrix are computed, the matching engine 102 calculates the similarity degree for each resource considering the hierarchical dependency among job attributes. As described in the example above, in one embodiment, the similarity degree between a resource and a job is a score that may be calculated by rescaling weights of job attributes initially determined by the scaling of preferences mechanism 102. A description of determining a score for a similarity degree between a resource and a job is described with respect to FIGS. 3 and 4.

FIG. 3 illustrates an example method 300 for scoring a resource for a job, according to an embodiment. The method 300 is described by way of example with respect to the system shown in FIG. 1. The method 300 may be practiced in other systems. One or more of the steps of the method 300 may be performed by the matching engine 102.

At step 301, job attributes for a job are determined. This may include the matching engine 102 retrieving the job attributes for the job from the jobs database 104.

At step 302, resource attributes for a resource that may be a candidate for the job are determined. This may include the matching engine 102 retrieving the resource attributes from the resource attributes database 103.

At step 303, a hierarchy of the job attributes are determined. This may include the matching engine 102 retrieving the hierarchy for the job determined by the scaling of preferences mechanism 102. The hierarchy includes weights and an order of the job attributes representing preferences between the job attributes.

At step 304, a score is determined from comparisons between the job attributes and the corresponding resource attributes, wherein the score represents a matching between the resource and the job considering the hierarchical dependencies of job attributes. The score and more detailed steps for determining the score are described with respect to a method 400 shown in FIG. 4.

FIG. 4 illustrates a method 400 for scoring a resource for a job, considering the hierarchical dependencies of job attributes, according to an embodiment. The method 400 is described by way of example with respect to the system shown in FIG. 1. The method 400 may be practiced in other systems. One or more of the steps of the method 400 may be performed by the matching engine 102. Also, many of the steps of the method 400 are sub-steps describing the details of one or more of the steps of the method 300.

At step 401, the hierarchy of job attributes for the job, including the weights are determined. For example, the scaling and dependency of preferences mechanism 102 determines this information, such as described in method 200. The matching engine 102 may retrieve the hierarchy from the jobs database 104.

At step 402, a similarity rule is applied to determine the similarity between a job attribute and a corresponding resource attribute. For example, the matching engine 102 applies the similarity rule, which may be a function. Note the same set of attributes are used to describe the job attributes and the resource attributes. For example, a job and resource are described by skill group, workforce type, and location, and a resource is described by the same set of attributes.

The similarity rule may be a function, referred to as a similarity function, that is calculated to determine the similarity (μ) between a job attribute and a corresponding resource attribute.

μ=sim(jobattributeₑ, jobattributeⱼ) Equation 1

Equation 1 represents the similarity function sim(jobattributeₑ, jobattributeⱼ), where jobattributeₑ and jobattributeⱼ are the corresponding resource attribute and job attribute, respectively. In one example, μ is a value between 0 and 1 inclusive and represents a similarity between the job attribute and the corresponding resource attribute. sim(jobattributeₑ, jobattributeⱼ) may be a business function that evaluates different attributes depending on the attribute domain.

One example of a similarity function is as follows. A job level attribute has one of the following values {1,2,3,4,5,6}. The similarity function evaluates if the resource job level is over-qualified or under-qualified for the job as follows:

$${μ}_{jobLevel} = \{ \begin{matrix}1 & {j}_{e} = {j}_{j} ; \\ 0.75 & {j}_{e} = {j}_{j} - 1 ; \\ 0.25 & {j}_{e} = {j}_{j} + 1 \\ 0 & otherwise\end{matrix} \qquad Equation 2$$

jₑ is the job level for the resource attribute and jⱼ is the job level for the job attribute. Assume a corresponding resource attribute for job level is 3 (i.e., jₑ=3), and the job attribute for job level is 1 (i.e., jⱼ=1). In this case, the resource is over qualified, assuming a higher job level value means a higher qualification.

The matching engine 102 applies the similarity function above by calculating μ_{joblevel} according to the function. So, for a given resource with jₑ=3 and a required job level jⱼ=1, μ_{joblevel}=0. Assuming jⱼ=1, if jₑ=2 then μ_{joblevel}=0.25, and if jₑ=1 then μ_{joblevel}=1. If jₑ=3 and jⱼ=2 then μ_{joblevel}=0.75, according to the similarity function. Thus, μ is the similarity value between a job attribute and a corresponding resource attribute and may be calculated from a similarity function. Hence, μ represents the similarity between a job attribute and a corresponding resource attribute, and may be determined at step 402.

At step 403, a determination is made as to whether the job attribute allows for flexible matching or non-flexible matching. The matching engine 102 may identify the flexibility type from meta data stored in the job database 104 that identifies the flexibility type for each job attribute. If the flexibility type allows having flexible matching, the similarity (μ) is calculated between 0 and 1, for example, as shown in Equation 2. If the flexibility type is non-flexible, then the similarity is 0 or 1 only.

At step 404, an attribute similarity score is calculated for the job attribute and the corresponding resource attribute. The attribute similarity score is calculated based on the similarity (μ) determined at step 402, the flexible or non-flexible matching type determined at step 403, and the weight for the job attribute determined from the hierarchy. Equation 3 below may be used to calculate an attribute similarity score, referred to as ass in the Equation.

assₐⱼ=μₐⱼ* wₐⱼ Equation 3

assₐⱼ is the attribute similarity score between a job attribute and a corresponding resource attribute. μₐⱼ is the similarity calculated from the similarity function, such as described with respect to step 402. wₐⱼ is the maximum weight for the job attribute, which is provided in the hierarchy from step 401.

Table 1 provides examples of computed attribute similarity scores for the following hierarchy of job attributes: skill group, domain, job level, workforce type, location type, and location ID.

TABLE 1

| Job | | | | | | Attribute |
|---|---|---|---|---|---|---|
| Attributes | Flexibility | Max | Resource | Job | Similarity | Similarity |
| Hierarchy | Type | Weight | Attributes | Attributes | Rule | Score % |
| Skill Group | Non- | 50 | SG01 | SG01 | Equal: 1 | 50 |
| | Flexible | | | | | |
| Domain | Flexible | 20 | 24 | 24 | Equal: 1 | 20 |
| Job Level | Flexible | 15 | 6 | 5 | Similar: 0.75 | 11.25 |
| Workforce | Flexible | 10 | 1 | 1 | Equal: 1 | 10 |
| Type | | | | | | |
| Location | Flexible | 4 | 0 | 1 | Not equal: 0 | 0 |
| Type | | | | | | |
| Location ID | Flexible | 1 | 3 | 3 | Similar: 1 | 1 |
| | | | | | Total | 92.25 |
| | | | | | Attribute | |
| | | | | | Similarity | |
| | | | | | Score | |

In Table 1, the similarity rule is applied to determine the attribute similarity scores for the job attributes and their corresponding resource attributes. In this example, the skill group is indicated as non-flexible likely because the resource must have the skill group specified by the job attribute to at least qualify for the job. The resource and the job attribute have the same skill group, and thus, p (shown as similarity rule) is 1. The attribute similarity score for the skill group is 50′1=50. For the domain job attribute, the values for the job attribute and the corresponding resource attribute are equal so the attribute similarity score is equal to the maximum weight. For job level, assuming the similarity function is the same as Equation 3, the similarity as 0.75. The attribute similarity score is 15*.75=11.25. For location type, the matching engine 102 uses determines that the job attribute and corresponding attribute are different, and assigns the attribute similarity score of zero based on a similarity function for location type. Location ID has equal values, arid the attribute similairity score is equal to the maximum weight.

At step 405, a determination is made as to whether an attribute similarity score needs to be determined for any other job attributes for the job. If yes, then steps 402-404 are repeated for each remaining job attribute in the hierarchy until an attribute similarity score is determined for all the job attributes in the hierarchy.

At step 406, one or more attribute similarity scores are re-scaled based on the hierarchy if a corresponding resource attribute is not a perfect match for the job attribute. The re-scaling of the attribute scores includes re-scaling of the attribute similarity score for the corresponding resource attribute that is not a perfect match for its respective job attribute, and also rescaling the attribute similarity scores for any job attributes in the hierarchy that are below the job attribute that is not a perfect match with its corresponding resource attribute. This step accounts for the dependency between the job attributes determined in the method 200. The re-scaling is further described with respect to Table 2 and Equation 5 below. Re-scaling is also described with respect to the method 200.

At step 407, a total flexible score is calculated from the attribute similarity score for each job attribute, which includes re-scaled attribute similarity scores determined from step 406. Weights for the job attributes are re-scaled depending on the hierarchy. The total flexible score is the score for matching a given resource to a given job. The total flexible score represents how close a match the resource is to the job. In one example, the higher the score, the closer the match between the resource and the job. A closer match may mean that the resource is more qualified for the job than resources with lower total flexible scores.

Equation 4 illustrates a function for calculating the total flexible score.

$${max\_rhs}_{i} = \{ \begin{matrix}{max\_rhs}_{i - 1} - \frac{{w}_{i}}{{\sum }_{k = 1}^{N} {w}_{k} * {ft}_{k}} & if {ass}_{i} != {w}_{i} \\ {max\_rhs}_{i - 1} & if {ass}_{i} = {w}_{i}\end{matrix} \\ {ms}_{e , j} = {\sum }_{i = 1}^{N} {max\_rhs}_{i} * {ass}_{i} \qquad Equation 4$$

The terms in Equation 4 mean the following:

ms_{e,j} is the matching score between the resource e and the job j;

max_rhs is the maximum rescaling hierarchy score at level i of the hierarchy (e.g., for each job resource);

assₐⱼ is the attribute similarity score between the resource and the job j;

ftⱼ is the flexibility type={0:non-flexible, 1: flexible} for a given job attribute;

wₖ is the maximum weight for a given job attribute;

i is the index of the hierarchy order of job attributes;

j is the job;

e is the resource; and

N is the number of job attributes.

Table 2 below illustrates an example of applying Equation 4 for re-scaling attribute similarity scores based on the hierarchy and calculating the total flexible score.

TABLE 2

| | | | | | | Max | |
|---|---|---|---|---|---|---|---|
| Job | | | | | Attribute | Rescaling | |
| Attributes | Flexibility | Resource | Max | Similarity | Similarity | Hierarchy | Score of |
| Hierarchy | Type | Attributes | Weight | Rule | Score % | Score % | Matching % |
| Skill Group | Non- | SG01 | 50 | Equal | 50 | 100 | 50 |
| | Flexible | | | | | | |
| Domain | Flexible | 24 | 20 | Equal | 20 | 100 | 20 |
| Job Level | Flexible | 5 | 15 | Similar | 11.25 | 70 | 7.875 |
| | | | | (.75) | | | |
| Workforce | Flexible | 1 | 10 | Equal | 10 | 70 | 7 |
| Type | | | | | | | |
| Location | Flexible | 0 | 4 | Not | 0 | 62 | 0 |
| Type | | | | Equal | | | |
| Location ID | Flexible | 3 | 1 | Equal | 1 | 62 | 0.62 |
| | | | | Total | 92.25 | Total | 85.495 |
| | | | | similar | | flexible | |
| | | | | score | | score | |

The column labeled Max Rescaling Hierarchy Score % shows the rescaling of attribute similarity scores. The attribute similarity scores for skill group and domain are not scaled because they are equal. The attribute similarity scores for job level and the attributes in the hierarchy below job level are re-scaled because job level is not a perfect match. Instead, it is similar.

To determine the re-scaling percentage, the max weights, which are the weights determined by the scaling and preference mechanism 101 for the job attributes in the hierarchy, for all the flexible type attributes are summed. In this example, the sum is 50. Then, the max weight 15 for the job level is subtracted from the sum, i.e., 50-15=35. Then, the max rescaling hierarchy score for job level is the ratio of 35/50=70%. Since workforce type is equal, its rescaling value is also 70%.

The rescaling value for location type is determined by summing the max weights for job level and location type. i.e., 15=4=19. The max weight for workforce type is not included because it is equal. Then, the max rescaling hierarchy score for workforce type is the ratio of 31/50=62%. Since location ID is equal, its rescaling value is also 62%.

At step 408, a resource transition for the resource is determined for the resource and the job. Automatic resource transitions are associated with predetermined job attributes when the matching engine determines the similarity degree between the resource and job is less than 1 (e.g., not %100 match). The transition rules provide information regarding resource qualifications for the particular attribute. For example, the transition rule may specify that a resource is under qualified or that the resource can be trained to become qualified based on the resource's secondary skills. Other information may also be specified. The flexible tool 100 determines the resource transition and may output the training that needs to be performed by the resource to qualify for the job if the resource has a predetermined skill set.

The method 400 is repeated for each resource that is a candidate for the job. A total flexible score is generated for each resource. From these scores, the resources having the top scores are identified as a suggested resource pool for the job. The top scoring resource may be selected for the job, or the top list of resources may be re-evaluated and a resource is selected based on the re-evaluation.

### 6. Computer System Platform

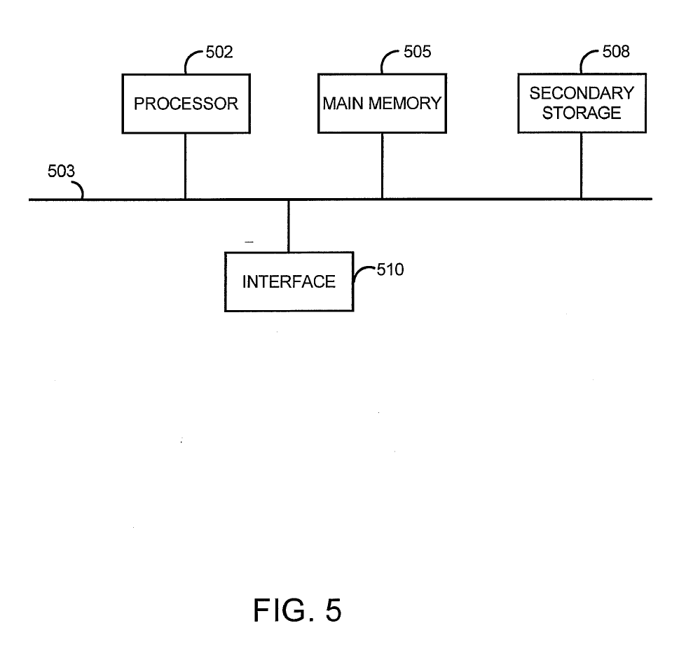

FIG. 5 illustrates a block diagram of an example general purpose computer system that is operable to be used to execute one or more computer programs implementing the embodiments described herein, including steps described herein. It will be apparent to one of ordinary skill in the art that a more sophisticated computer system is operable to be used. Furthermore, components can be added or removed from the computer system 500 to provide the desired functionality.

The computer system 500 represents a platform that may be used for the system 100 and as a computer platform for performing the methods and other function described herein. One or more of the components of the flexible matching tool 100 and methods and steps described herein may be implemented as software stored on a computer readable medium and executed b the computer system 500. The computer system 500 includes one or more processors or processing circuitry, such as processor 502, providing an execution platform for executing software. Commands and data from the processor 502 are communicated over a communication bus 503. The computer system 500 also includes computer readable storage mediums including a main memory 505, such as a Random Access Memory (RAM), where software is resident during runtime, and a secondary storage 508. The secondary storage 508 may include nonvolatile memory where a copy of the software is stored. The computer system also include an interface 510. The interface 510 may include a network interface and/or other types of interfaces.

One or more of the steps of the methods described herein and other steps described herein and one or more of the components of the systems described herein may be implemented as software code stored on a computer readable storage medium, such as the memory and/or secondary storage, and executed on a computer system, for example, by a processor. For example, the steps of the embodiments may exist as software program(s) comprised of program instructions in source code, object code, executable code or other formats for performing some of the steps.

While the embodiments have been described with reference to examples, those skilled in the art will be able to make various modifications to the described embodiments without departing from the scope of the claimed embodiments.

1. A method of scoring a resource for a job, and the method is performed by a computer system executing computer code stored on a computer-readable storage medium, the method comprising:
identifying job attributes for the job;
identifying corresponding resource attributes for a resource, wherein the corresponding resource attributes correspond to the job attributes;
determining a hierarchy of the job attributes that includes dependencies between the job attributes; and
determining a score for the resource using the hierarchy of the job attributes and the resource attributes, wherein the score represents a matching between the resource and the job.

2. The method of claim 1, wherein the score indicates a degree of similarity between the resource and the job when the resource is not fully qualified for the job.

3. The method of claim 1, wherein determining a score for the resource further comprises:
for each job attribute, calculating a similarity between the job attribute and a corresponding resource attribute for the resource using a similarity function.

4. The method of claim 3, wherein determining a score for the resource further comprises:
for each job attribute, determining whether the job attribute allows for flexible matching or non-flexible matching.

5. The method of claim 4, wherein determining a score for the resource further comprises:
for each job attribute and each corresponding resource attribute, calculating an attribute similarity score using the similarity calculated from the similarity function and based on whether the job attribute allows for flexible matching or non-flexible matching.

6. The method of claim 5, wherein determining a score for the resource further comprises:
re-scaling one or more of the attribute similarity scores based on the hierarchy, and based on whether a job attribute and the corresponding resource attribute for the job attribute are a perfect match, and based on whether job attributes allow for flexible matching or non-flexible matching.

7. The method of claim 6, wherein the score for the resource is a total flexible score, and the method further comprises:
calculating the total flexible score from the attribute similarity scores or the re-scaled attribute similarity scores.

8. The method of claim 4, wherein the similarity is 0 or 1 if non-flexible matching is allowed, and the similarity is between 0 and 1 if flexible matching is allowed.

9. The method of claim 8, further comprising:
using the similarity function to determine the similarity between 0 and 1.

10. The method of claim 5, wherein the hierarchy of job attributes includes weights for each job attribute based on its relationship with other job attributes, and calculating an attribute similarity score further comprises:
for each job attribute, calculating the attribute similarity score based on the weight for the job attribute.

11. The method of claim 10, wherein the attribute similarity score is a weight or a percentage of the weight for the job attribute.

12. A method of scoring a resource for a job, and the method is performed by a computer system executing computer code embodying the method and the computer code is stored on a computer-readable storage medium, the method comprising:
identifying job attributes for the job;
identifying corresponding resource attributes for a resource, wherein the corresponding resource attributes correspond to the job attributes;
determining a hierarchy of the job attributes that includes dependencies between the job attributes, wherein the hierarchy of job attributes includes weights for each job attribute based on its relationship with other attributes of the job attributes; and
determining a score for the resource using the hierarchy of the job attributes and the resource attributes, wherein the score represents a matching between the resource and the job.

13. The method of claim 12, wherein determining a hierarchy of the job attributes further comprises:
receiving a value for each pair of the job attributes, wherein the value represents a comparison of importance between the pair of job attributes to the job; and
determining the hierarchy from the values for the pairs of job attributes.

14. A computer system comprising:
a data storage device storing job attributes for a job and storing corresponding resource attributes for a resource, wherein the corresponding resource attributes correspond to the job attributes;
a processor determining a hierarchy of the job attributes that includes dependencies between the job attributes; and determining a score for the resource using the hierarchy of the job attributes and the resource attributes, wherein the score represents a matching between the resource and the job.

15. The computer system of claim 14, further comprising:
an interface receiving a value for each pair of the job attributes, wherein the value represents a comparison of importance between the pair of job attributes to the job; and
the processor determining the hierarchy from the values for the pairs of job attributes.
